(19) United States
(12) Patent Application Publication
(10) Pub. No.: US 2014/0278629 A1
(43) Pub. Date: Sep. 18, 2014

(54) METHOD FOR EMPLOYEE PARAMETER TRACKING

(71) Applicant: PayrollHero.com Pte. Ltd., Vancouver (CA)

(72) Inventors: Michael Candine Stephenson, Whistler (CA); Stephen Patrick Jagger, Vancouver (CA); Piotr Banasik, Burnaby (CA); Adam Tyler Baechler, Whistler (CA)

(73) Assignee: PayrollHero.com Pte. Ltd., Vancouver (CA)

(21) Appl. No.: 14/207,264

(22) Filed: Mar. 12, 2014

Related U.S. Application Data
(60) Provisional application No. 61/778,100, filed on Mar. 12, 2013.
(60) Provisional application No. 61/777,226, filed on Mar. 12, 2013.

(51) Int. Cl. G06Q 10/06; G06Q 10/10

(52) U.S. Cl. CPC G06Q 10/06311; G06Q 10/109
USPC 705/7.13

(57) ABSTRACT

A method for employee attendance monitoring, including: receiving biometric information unique to an employee, the biometric information including a timestamp; identifying the employee based on the biometric information; updating a work record associated with the employee based on the timestamp in response to employee identification; analyzing the biometric information to extract a physiological parameter of the employee; updating a physiological record associated with the employee; and generating a recommendation for an employer based on the physiological record associated with the employee.

### CROSS-REFERENCE TO RELATED APPLICATIONS

This application claims the benefit of U.S. Provisional Application No. 61/778,100 filed 12 Mar. 2013, and U.S. Provisional Application No. 61/777,226 filed 12 Mar. 2013, which are incorporated in its entirety by this reference.

### TECHNICAL FIELD

This invention relates generally to the field of timecards, and more specifically to a new and useful method for tracking work hours of an employee in the timecard field.

### BACKGROUND

Punching-in, clocking-out, timecards, and timesheets define common employee actions and methods of tracking employee work hours. However, timecards and timesheets filled out by hand individually by employees are prone to error, and present systems provide few barriers or protections against purposefully falsified or fraudulent work hour records. The problem of falsified timecards and timesheets has become so common that the term “ghost employee” has become ubiquitous for an employee who clocks work hours but who is not physically present at a job site or does not complete work suggested on a time card. Thus, there is a need in the field of timecards to create a new and useful method for tracking work hours of an employee. This invention provides such a new and useful method.

### BRIEF DESCRIPTION OF THE FIGURES

FIG. 1 is a flowchart representation of the method of monitoring employee parameters.

FIG. 2 is a schematic representation of a variation of the method of monitoring employee parameters.

FIG. 3A is a flowchart representation of a first embodiment of the method.

FIG. 3B is a flowchart representation of a variation of the first embodiment.

FIG. 4A is a flowchart representation of a second embodiment of the method.

FIG. 4B is a flowchart representation of a variation of the second embodiment.

FIG. 5 is a graphical representation of a variation of an input region and an output.

FIG. 6 is a graphical representation of a variation of an output.

FIGS. 7-10 are graphical representations of several variations of the method.

FIG. 11 is a graphical representation of a variation of the method wherein a recommendation is generated for the employee based on the extracted physiological parameter.

### DESCRIPTION OF THE PREFERRED EMBODIMENTS

The following description of the preferred embodiment of the invention is not intended to limit the invention to these preferred embodiments, but rather to enable any person skilled in the art to make and use this invention.

As shown in FIG. 1, the method for employee parameter tracking includes receiving biometric information unique to an employee at a first time S100; identifying the employee based on the biometric information S200; updating a work record associated with the employee based on the first time in response to employee identification S300; analyzing the biometric information to extract a physiological parameter of the employee S400; updating a physiological record associated with the employee S500; and generating a recommendation for an employer based on the physiological record associated with the employee S600. This method functions to utilize the employee biometric information in multiple ways. First, the method functions to verify employee attendance (e.g., check-in or check-out) based on the biometric information unique to the employee, thereby reducing work hour falsification. Second, this method functions to extract physiological parameters of the employee from the recorded biometric information that was used to verify employee attendance, wherein the physiological parameters can be used to determine employee satisfaction, emotion, stress, or any other suitable employee parameter relevant to work productivity. Third, this method can additionally function to generate rewards for the employee based on the respective work record, wherein the rewards can be presented in real-time to the employee upon employee recognition based on the biometric information during employee check-in or check-out. Fourth, this method can additionally function to verify employee absentee excuses (e.g., verify medical excuses) based on the record of biometric information across a given period of time (e.g., based on manifested physiological parameter patterns determined within the physiological record). However, the method can utilize the biometric information in any other suitable manner.

The method is preferably applicable to a workforce, wherein employees engage a machine or device enabling the method to clock-in and -out of work. The work record is preferably a form of a digital payroll timesheet or timecard that includes a first time that is a ‘clock-in’ time at which the employee begins work and a second time that is a ‘clock-out’ time at which the employee stops work; the work record can also include a total time worked during a shift, workday, or workweek that is the difference between the first and second times, as shown in FIG. 5. Work hours, clock-in times, and clock-out times of the employee and/or other employees can also be managed from a single digital interface, such at the interface shown in FIG. 6. However, the method can be applicable to other scenarios and uses, such as logging community service hours, monitoring individuals at a standardized testing facility, or tracking attendance at a school, though the method can implemented in any other scenario.

At least a portion the method is preferably implemented as a local or native application executing on an electronic device incorporating the camera. For example, the employee can use a smartphone incorporating a camera to take a image of himself, wherein a native application executing on the smartphone identifies the employee in the image, and updates the work record of the employee by pushing the clock-in or -out selection, clocking time, and employee identity to an employee work record that is stored on a remote server or network. A portion of each of the method can also be implemented on a remote server or network in communication with the electronic device. For example, the employee can use a desktop computer incorporating a camera to take a image of himself, wherein the computer pushes the time and image to the remote server or network, wherein the remote server or network identifies the employee in the image and updates the work record of the employee accordingly, wherein the work record is stored on or is accessible by the remote server or network. However, the first and second preferred methods can be implemented in any other way by any one or more devices, networks, or remote servers. However, the camera can be separate from and electrically coupled to the electronic device, remote server, or network. However, the method can be performed in any other way and by any other entity.

The electronic device that implements at least a portion of the method can be any of a smartphone, a tablet, a laptop computer, a desktop computer, a digital music player, a personal data assistant (PDA), a standalone electronic timecard machine, smartwatch, or any other suitable electronic device. The device preferably includes a data input, such as a touchscreen, keyboard, or mouse. The device preferably includes a data output, such as a display (e.g., screen) or a speaker. The device preferably additionally includes a sensor or recording device, such as an optical sensor (e.g., RGB camera, IR camera, etc.), an acoustic sensor (e.g., a microphone), a pressure sensor, a temperature sensor, or any other suitable sensor, or can include a data input that functions to receive measurements or other data from a sensor or recording mechanism removably coupled to the device. In one variation, the electronic device is employee-specific, wherein the employee punches his digital timecard (i.e. updates his work record) by accessing his own smartphone, tablet, computer, or other electronic device. In this variation, the electronic device specific to the employee can be within or in communication with a network including other electronic devices specific to other employees, wherein the employee and other employees are a workforce sector of a company. In another variation, the electronic device is employee-generic, wherein the single electronic device can be used to update work records and timecards of multiple employees. For example, the electronic device can be a smartphone that is passed around a construction site as employees who are construction workers arrive and begin work or stop work and leave.

In one variation, the electronic device is mounted to or associated with a particular location. For example, the electronic device can be a standalone timecard machine or a desktop computer arranged at a check-in or clock-in location on a company campus or worksite. In another variation, the electronic device is substantially mobile. For example, the electronic device can be a smartphone or a tablet owned by or provided to the employee, wherein the employee can engage the electronic device while in a variety of locations to clock-in or -out. In this variation, the employee is preferably restricted from clocking-in or -out when not on a company campus, at a worksite, or proximal a work-related location.

Receiving biometric information unique to the employee at a first time S100 functions to record information that uniquely identifies the employee. Receiving biometric information preferably includes recording the biometric information, and can additionally include sending the biometric information. The biometric information is preferably associated with a timestamp, wherein the timestamp reflects the time at which the biometric information was recorded. Alternatively, the timestamp can reflect the time at which the biometric information was received. The biometric information is preferably recorded by a sensor of the device, but can alternatively be recorded by a secondary sensor or recording mechanism. The sensor or recording mechanism can be a camera, a microphone, an ultrasound monitor, a resistometer, an IR sensor, or any other suitable sensor or recording mechanism. The biometric information is preferably recorded in response to receipt of an input from the employee, such as receipt of an attendance status (e.g., check-in or check-out), receipt of a start selection, or receipt of any other suitable input. Alternatively, the biometric information can be recorded in response to detection of a target object (e.g., face) within the measurement area of the sensor (e.g., field of view of a camera). However, the biometric information can be recorded in response to the occurrence of any other suitable recording event. The biometric information can be recorded by the device and sent to a remote processor (e.g., server system) for analysis, can recorded by the device and analyzed by the device, recorded by a sensor and sent to the device, or recorded by any other suitable component and analyzed by any other suitable component of the system. Recording the biometric information preferably includes measuring signals with a sensor, and can additionally include transmitting or emitting signals (e.g., light waves of a given frequency, audio waves of a given frequency, etc.).

The biometric information recorded by the method functions to uniquely identify the employee. The biometric information is preferably an optical image (e.g., photograph, etc.) or an optical video (e.g., recorded by an optical sensor, such as a camera), but can alternatively be an acoustic recording (e.g., recorded by an ultrasound mechanism), pressure pattern, or any other suitable record of biometric information. The biometric information is preferably facial features, wherein the image is of a face of the employee, but can alternatively be optical features (e.g., of an employee eye), digit features (e.g., fingerprints, capillary patterns, etc.), or any other suitable biometric information. The biometric information preferably includes at least one recording from one recording device, but can alternatively include multiple recordings taken sequentially or simultaneously by one or more devices. Examples of biometric information include an image of a portion of the user (e.g., using a camera that captures images in the visual light spectrum), a heat recording of the user (e.g., using an IR or other thermal sensor), a voice recording of the user, or any other suitable biometric information. Examples of employee portions that can be measured include the face, eye(s), fingers (e.g., fingertips, capillaries), or any other suitable body part. For example, an optical image, an IR reading of the subcutaneous capillaries, and a pressure readout of an employee digit (e.g., finger) can be simultaneously recorded.

As shown in FIGS. 3B and 4B, the method can additionally include determining the location of the employee. The location of the employee is preferably determined from the identity of the sensor or device, but can alternatively be determined from a location sensor of the device (e.g., a GPS sensor, a cellular triangulation mechanism, a WiFi triangulation mechanism, etc.), determined from the network from which the biometric information was received (e.g., the internet protocol address), or determined in any other suitable manner. The location is preferably associated with the biometric information of the employee, but can alternatively be associated with the information extracted from the biometric information, such as the employee identity or physiological parameters. Alternatively, the ambient environment of the biometric information (e.g., the background of an image, the background noise of an audio recording, etc.) can be analyzed to determine or confirm the location at which the biometric information was recorded. Location data can be used in a variety of ways. In one variation, the location information is used to verify that the employee is in the place of employment or a location associated with an employer of the employee. In another variation, geo-fencing is used to verify that the employee is proximal a predefined work location before the employee is allowed to clock-in or -out. In another example implementation, different timesheets or portions thereof associated with different work locations or job sites are updated according to employee location. In a further example implementation, location data can be used to serve location-specific advertisements to the employee. However, location data can be used in any other way.

Receiving biometric information can additionally include incentivizing the employee to record the biometric information. Incentivizing the employee to record the biometric information preferably includes using biometric information recording as the sole method of recording attendance. Alternatively or additionally, incentivizing the employee to record biometric information can include providing rewards, such as bonuses, coupons, or other suitable rewards, for recording biometric information. Alternatively or additionally, incentivizing the employee to record biometric information can include physically limiting employee accessibility unless the biometric information is recorded (e.g., a locked door unlocks in response to biometric information recordation). However, the employee can be otherwise incentivized to record biometric information.

In one variation of the method, incentivizing the employee to record biometric information includes rewarding an employee for recording the biometric information. Rewarding the employee for recording the biometric information can function to incentivize the employee to clock-in and clock-out. Rewarding the employee for recording the biometric information can include presenting the employee with tangible or electronic rewards according to positive clocking actions. Rewarding the employee for recording the biometric information can include rewarding the employee according to single clocking actions (e.g., a clock-in or a clock-out), paired clocking actions (e.g., a clock-in followed by a clock-out), or sets of clocking actions (e.g., a full work week of morning clock-ins and afternoon clock-outs).

In one example, rewarding the employee for recording the biometric information includes rewarding the employee with electronic points in response to positive clocking actions. For example, each time the employee clocks-in, incentivizing the employee includes rewards the employee with a set number of points that is common to all clocking actions by all company employees. Alternatively, rewarding the employee for recording the biometric information can include implementing point tiers, wherein the employee graduates to higher point tiers characterized by larger point payouts for positive clocking actions with subsequent positive clocking actions. In this example, the employee can redeem awarded points for a prize internal to the business or office, such as a raffle or lottery ticket for an internal raffle or lottery, a coupon for in-office vending machine, or a free cafeteria lunch. Alternatively, the employee can redeem the points for an external prize, such as a ticket for a state lottery, a coupon for a sandwich at a local deli, or a free or discounted airfare. In this example, the employee can access a clocking profile to review points issued to him and to exchange the points for various available rewards.

In another example, rewarding the employee for recording the biometric information can include rewarding the employee with a digital or tangible raffle or lottery ticket. This example can be similar to the foregoing example, though in this example, an internal or external raffle or lottery ticket can be issued directly to the employee without first issuing and then converting points. Similarly, in another example, rewarding the employee for recording the biometric information can include issuing electronic or tangible coupons redeemable for physical prizes, such as a bottle of soda, a bag of chips, or a free lunch. However, any other type of prize or number of points can be issued to the employee in any other way and according to any other clocking regulations or incentives.

Identifying the employee based on the biometric information S200 functions to uniquely identify the employee for recording purposes. The employee is preferably identified based on facial recognition or other machine vision techniques to identify an employee within the biometric information (e.g., image). The biometric information is preferably analyzed for markings, measurements, or patterns unique to the employee (or across individuals), and the subsequent unique identifier (the marking, measurement, or pattern) matched against a stored database of employee identifiers. For example, a recorded image of an employee fingerprint can be matched against a database of fingerprints, and the employee uniquely identified from the fingerprint pattern extracted from the image.

In one variation of the method, facial recognition or another suitable machine vision technique to identify the employee in a static image or in a live video feed generated by the camera, as shown in FIG. 9. Facial recognition algorithms that extract landmarks or features from a camera image of the face of the employee can be used, wherein relative position, size, and/or shape of the eyes, nose, cheekbones, jaw, or any other facial feature is analyzed. Alternatively, three-dimensional facial recognition algorithms that extract key depth-related features on the surface of a face, such as the contour of an eye socket, the nose, or the chin. Once key features or landmarks of the face of the employee are isolated, the system can access a gallery of face images or a record of facial parameters (e.g., including facial feature measurements) for a set of employees including the employee, wherein identifying the employee can include matching features in the camera image with features in an image in the image gallery. Furthermore, the image gallery can include compressed face image data, wherein each face image includes only image data that is useful for face detection, such as specific identifying features.

In one variation, identifying the employee based on biometric information S200 includes parsing through the gallery of face images until a match is found, such as through template matching. In another variation, the method includes receiving an input that suggests the identity of the employee, such as from the employee himself. For example, the employee can input or select an identity field that is at least one of his name, login ID, badge number, employee number, or driver's license number, wherein each face image in the gallery of face images is tagged with an identity field, and wherein a particular face image is selected from the gallery for comparison with the field of view of the camera based upon a matching identity field. Similarly, the electronic device can be associated with the particular employee or employee group, wherein an identifier of the electronic device points to a particular face image or subset of face images in the image gallery, wherein the identifier informs selection of a face image from the gallery for comparison with the camera image of the employee. However, the employee can be identified in the field of view of the camera (i.e. camera image) in any other way.

The electronic device including the camera preferably also includes a display. In one variation, the field of view of the camera is rendered on the display while the employee clocks-in or -out. In this variation, a digital guide can also be rendered on the display, wherein the digital guide is overlaid on top of the field of view of the camera shown on the display, wherein the digital guide advises location of the face of the employee within the field of view of the camera. The guide can be an alignment guide for eye alignment, face perimeter alignment, or alignment of any other suitable facial or body feature. For example and as shown in FIG. 7, the digital object can be a pair of glasses and a mustache, wherein the employee must align his face with the glasses and mustache in order to be identified. In this variation, alignment of the face of the employee with the digital guide can place the face of the employee in the field of view of the camera at a proper depth, latitude, and longitude from the camera to identify the employee. In this variation, alignment of the face of the employee with the digital guide can additionally or alternatively inform selection of a face for analysis when multiple faces are in the field of view of the camera, such as when the employee is clocking-in or -out while standing next to at least one other person. Furthermore, in this variation, by requiring the employee to align his face with the digital guide, the employee can be forced to move his head, the camera, and/or the electronic device in order to achieve proper alignment. As the employee changes the orientation of his head relative to the camera, the field adjacent the face of the employee can be analyzed, wherein a field that does not change or does not properly change in content and/or perspective as the camera moves relative to the head of the employee can indicate that the face shown in the field of view of the camera is a representation (e.g., photograph) of the employee rather than the employee himself. This can yield the benefit of identifying instances in which a second individual is attempting to clock-in or -out for the employee by presenting a image or other image of the employee to the camera. In this variation, the digital guide is preferably pseudorandomly selected from a set of digital guides, though the guide can be selected in any other way and can be of any other form or object. However, the employee can be identified in any other manner. Furthermore, the camera used to clock in can be the same camera used to clock out, such that the employee can clock-in and clock-out with the same electronic device implementing the same camera. Alternatively, the cameras can be different, such that the employee can clock-in and clock-out with different electronic devices, each implementing a camera.

If the employee or a representative of the employee attempts to clock-in or -out and the employee is not positively identified, such as in a case in which there is no positive match in the image gallery for the employee or a image of the employee is identified in the field of view of the camera rather than the employee himself, the work record, timecard, profile, etc. of the employee can be flagged. Once flagged, another employee, such as a human resources representative, can review the image of the employee to ascertain whether the negative match was a system error, poor lighting, or deceitful intent of the employee or representative thereof. However, negative matches can be handled in any other way.

In another variation of the electronic device that includes the display, an advertisement or reward can be rendered to the display when the employee clocks-in or -out, as shown in FIGS. 7 and 8. The advertisement is preferably based upon the time at which the biometric information is received by the system (e.g., whether the employee is clocking-in or-out) and the determined attendance status of the employee (e.g., whether the employee is checking in or out of the workplace). The advertisement or reward can additionally be determined based on the work record of the employee (e.g., a first advertisement or reward displayed to employees having an attendance rate over a first threshold and a second advertisement or reward displayed to employees having an attendance rate over a second threshold). The advertisement or reward can additionally be based on the biometric information or extracted physiological parameter of the employee (e.g., a dessert selected in response to the employee emotion determined to be sad, a beverage selected in response to the employee emotion determined to be happy). Alternatively, the advertisement can be based upon a pay rate of the employee, a demographic of the employee, a history of the employee, or any other metric or employee data. In one example, if the employee is clocking-in at 9 am on a Monday, the advertisement can be for coffee at a local coffee shop or for a daily deal at a local lunch location. In another example, if the employee is clocking-out at 5 pm on a Friday and the employee is not married, the advertisement can be for a happy hour at a local bar. In a further example, a first employee who is married without children and has an annual salary of $200k can be presented with an advertisement for a coupon for a five-star restaurant when clocking-out on a Tuesday evening, whereas a second employee who is married with three children and has an annual salary of $50k can be presented with an advertisement that is a coupon for $1 off a 5 lb. bag of boneless chicken breasts at Safeway when clocking-out on a Tuesday evening. Because the first and second preferred methods are preferably implemented in a work environment, data including pay rate (e.g., from a pay stub), marital and dependent status (e.g., from a W-2), and habits (e.g., from employee clocking trends) can be accessed and analyzed to inform advertisement selection. However, the advertisement can be selected according to any other schema, and the content of the advertisement can be for any other product, service, or experience.

Updating a work record of the employee S300 functions to record employee attendance. The work record is preferably a work record of the employee, but can alternatively be a work record shared amongst multiple employees. The work record is preferably updated with the timestamp of the biometric information. The work record can additionally be updated with the attendance status of the employee, wherein the method can additionally include determining the attendance status of the employee S310. The work record is preferably updated in response to positive identification of the employee from the biometric data. The work record is preferably automatically updated in response to employee identification, but can alternatively be updated in response to receipt of an employer verification or in response to any other suitable event. For example, if the employee enters a workplace at 8:54 am on 28 Mar. 2012, is positively identified and selects a ‘clocking-in’ input, an electronic timecard of the employee is updated to reflect that the employee clocked-in at 8:54 am on 28 Mar. 2012 S130 or S220. Furthermore, if the employee is positively identified and selects a ‘clocking-out’ input at 5:17 pm on 28 Mar. 2012, the electronic timecard of the employee is updated to reflect that the employee clocked-out at 5:17 pm on 28 Mar. 2012. In this example, the employee can be further noted as having worked eight hours, 11 minutes on 28 Mar. 2012, barring any other recorded absences or break. Updating the work record of an employee can additionally include sending the employee a notification or a receipt of check-in or check-out confirmation.

Determining the attendance status of the employee S310 functions to determine whether the employee is clocking in or clocking out (e.g., entering or leaving). The attendance status assists in determining the pay of the employee, wherein the pay of the employee is only calculated for the duration between clocking in and clocking out, and is not calculated for the duration between clocking out and clocking in.

In one variation of determining the attendance status of the employee, the timestamp of the biometric information (or the timestamp at which the biometric information was received) is compared to a work schedule for the employee, wherein the work schedule for the employee preferably includes a start time and a stop time. The attendance status of the employee can be categorized as a clocking-in status in response to the biometric information timestamp falling within a threshold time of the start time, and as a clocking-out status in response to the biometric information timestamp falling within a threshold time of the stop time. Alternatively, the attendance status can be determined based on the last recorded attendance status, wherein the determined attendance status is the opposite of the last recorded attendance status. The determined attendance status can additionally be determined based on the time since the last recorded attendance status, the mode of the last recorded attendance status, or any other suitable parameter. For example, if the last recorded attendance status was a check-in status within four hours of the biometric information timestamp, then the determined attendance status can be a check-out status. Alternatively, if the last recorded attendance status was a check-in status within forty hours of the biometric information timestamp, then the determined attendance status can be a check-in status.

A second variation of determining the attendance status of the employee S310 includes receiving the attendance status from the employee for one of a clock-in selection and a clock-out selection. The biometric information is preferably recorded in response to receipt of the attendance status, but can alternatively be recorded before receipt of the attendance status, be recorded independently of attendance status receipt, or received in any other suitable manner. The attendance status is preferably received as a selection by the employee, but can alternatively be received as an audio recording (e.g., spoken by the employee), or received in any other suitable manner. In the variation of the electronic device that includes a display, the display is preferably a touch display configured to capture the input from the employee that is provided on the display and that indicates whether the user is clocking-in, clocking-out, starting a break, ending a break, etc. As shown in FIGS. 5, 7, and 8, the display can include an input region, wherein the employer can tap, swipe, pull, push, pinch, spread, or provide any other gesture to indicate an intended action or status. Furthermore, multiple input regions can be displayed simultaneously. For example, a first input region can capture a swipe in a first direction (e.g., leftward) that indicates clocking-out and a second input region can capture a swipe in a second direction (e.g., rightward) that indicates clocking-in. However, the input region can be of any other form and capture any other input from the employee, and the employee clocking selection can be provided in any other way or through any other device.

Updating the work record of the employee S300 can additionally include comparing the work record of the employee with the work schedule of the employee, examples of which are shown in FIGS. 5 and 7. This can function to determine whether the employee is going to work and/or leaving work on time, whether the employee is absent, whether the employee is working overtime, determining an amount of time worked by the employee, or determine any other suitable payroll or attendance parameter for the employee. The work record is preferably updated in response to employee identification from the biometric information, but can alternatively be updated in response to attendance status determination, in response to determination of a clocking-out attendance status, or in response to any other suitable event. Updating the work record of the employee can additionally include identifying any differences between the work record of the employee and the work schedule of the employee, and generating a notification based on the difference. In one variation of the method, the difference between the work record and the work schedule is identified in real time in response to identification of the employee within the biometric information, and a notification or suggestion can be displayed or otherwise presented to the employee or another user. For example, the method can determine that the employee is clocking out one minute early, and display a notification to the employee that they are leaving one minute early. In another example, the method can determine that the employee is late beyond a threshold time period, and adjust employee payment accordingly (e.g., reduce payment on an employee payroll) or notify an employer or manager of the employee tardiness. In another example, the method can determine that the employee has worked overtime, and generate a notification (e.g., a reward or any other suitable notification) in response to the determination.

Updating the work record of the employee can additionally include comparing a time at which the biometric information was received and the time at which the biometric information was recorded. This can be particularly relevant if the biometric information is recorded on the employee device. In response to the timestamp of biometric information receipt and the timestamp of biometric information recording exceeding a predetermined time threshold, a notification to re-record the biometric information can be generated and sent to the respective employee.

Updating the work record of the employee S300 can additionally include verifying employee attendance by monitoring social networking systems for posts generated by user accounts associated with the employee. The content of the posts can additionally be analyzed to determine whether the employee is at the location of employment and/or working. For example, the background of an image posted by the employee can be analyzed to determine whether the background matches the background of the location of employee employment.

Analyzing the biometric information to extract a physiological parameter of the employee S400 functions to determine metrics indicative of predicted employee productivity. Such metrics include employee stress, emotion, health, or any other suitable metric. The physiological parameters are preferably extracted from the biometric information, but can alternatively be extracted from a second measurement recorded serially or concurrently with the biometric information. The physiological parameters can be extracted by image or video analysis (e.g., filtering the image or video for changes in skin coloration, filtering the image to amplify micromovements, etc.), but can alternatively be extracted in any other suitable manner. The physiological parameters extracted by the method function to indicate a physiological state of the employee. The physiological parameters are preferably indicative of emotion, but can alternatively be indicative of employee health (e.g., chronic or acute conditions) or any other suitable employee parameter. Extracted physiological parameters can include skin resistance, blood oxygen levels, blood pressure, amount of pupil dilation, amount of skin color change, amount of micro-movements (e.g., used to determine the employee heart rate), or any other suitable physiological parameter.

A variation of the method can further include categorizing the mood of the employee. This variation preferably implements machine vision techniques to analyze facial features to determine the mood of the employee. Facial features indicative of employee mood can include posture, skin wrinkles around the eyes, mouth, or forehead, or muscle position around the face, though any other facial feature can also be analyzed to determine employee mood, as shown in FIG. 10. Furthermore, in this variation, the employee is preferably tagged with the determined mood when clocking-in or clocking-out, though the employee mood can additionally or alternatively be compiled in a set of moods of multiple employees, such as for an employee group within a company, for employees at a particular company campus or location (e.g., city or state), for all employees at a company, or for employees of a particular demographic.

Analyzing the biometric information to extract a physiological parameter of the employee S400 can additionally include extracting an ambient environment parameter from the biometric information. The ambient environment parameter can be used to verify the location of the employee during biometric information recording, as described above. The ambient environment parameter can additionally be used to adjust the extracted physiological parameter (e.g., normalize the extracted physiological parameter for environmental effects). For example, a positive employee emotion can be discounted in response to the ambient environment parameter exceeding a lumen threshold (e.g., indicative of a sunny day). In another example, a negative employee emotion can be increased (e.g., made more positive) in response to the ambient environment parameter exceeding a moisture threshold (e.g., indicative of rain).

Updating a physiological record associated with the employee S500 functions to maintain a record of the physiological record for the employee. The physiological record preferably stores the extracted physiological parameters for the employee over a period of time. The physiological record for the employee can be used to predict employee performance, generate recommendations or notifications for employers, verify attendance excuses, or used in any other suitable manner.

In one variation, employee physiological parameters are tracked and the current determined physiological parameters of the employee is compared against past physiological parameters data of the employee. For example, the current emotion of the employee can be compared against past employee emotion patterns. In this variation, trends in employee physiological parameters can indicate changes in employee job satisfaction, general employee disposition, changes in employee health, the effect of work environment or workload on the employee, or any other suitable employee parameter. However, the employee physiological parameters can be otherwise determined.

Generating a recommendation for an employer S600 functions to notify the employer of an imminent drop in employee productivity, for example due to stress, dissatisfaction, bullying, sickness, or any other suitable adverse event. The recommendation can additionally or alternatively be generated to recommend employer actions that can be taken to improve employee productivity, such as changes in the workplace, changes in employee scheduling, or changes in group compositions. However, any other suitable notification can be generated based on the physiological record of the employee. The notification is preferably generated in response to an employee physiological parameter change beyond a threshold rate, but can alternatively be generated in response to a physiological parameter of the employee falling below a predetermined threshold, in response to a physiological parameter of the employee remaining below a predetermined threshold for a predetermined period of time, or in response to any other suitable trigger event.

The physiological record can influence replacement of the employee, changes to the type or form of work assigned to the employee, adjustment of employee workload, shift of the employee to a different department, or changes to a work environment. For example, trends indicating diminishing employee satisfaction over time, such as increasing frequency of anxiety, unhappiness, stress, or other negative indicators when checking-in or -out, can trigger changes to employee work or work environment before the employee finds grounds to file a complaint, before the employee finds reason to leave the company, or before employee work output drops below a threshold quality or quantity. This variation can therefore yield the benefit of providing job satisfaction, employee disposition, or other work-related indicators of the particular employee.

Data from other sources can be associated with the physiological parameter of the employee to generate or trigger the notification. Examples of such data include, relationships with coworkers, physiological parameters of coworkers (e.g., emotions of coworkers), types of work given to the employee, employee workload, etc., which can function to better inform changes in employment or function of the employee. Generally, physiological parameter trends of the employee are compared against physiological parameter trends of coworkers to isolate abnormalities between the employee and his coworkers. Differences between the employee and his coworkers, over time or in particular instances, can inform changes directed primarily toward the employee. Alternatively, positive or negative trends shared between the employee and his coworkers, over time or in a particular instance, can inform more global changes, such as changes to a whole work environment or employee hierarchy. For example, emotion analysis that consistently shows the employee in a company group to be unhappy when checking-in or -out, whereas other employees in the company group are consistently determined to be happy or satisfied, can suggest that the employee is not getting along with other employees in the group, thus indicating that the employee should be moved or replaced. Alternatively, such comparison between the employee and his coworkers can suggest that the employee has assumed much more responsibility for group progress or output than other employees in the group, thus indicating that the employee should be recognized and/or promoted for his efforts. Assessment of emotion indicators of the employee or groups of employees can additionally include receiving human input, such as from a manager or human resources representative, to implement proper or corrective procedures for single-instance or trending mood indicators of one or more employees, though mood data can be used in any other way.

Furthermore, physiological parameter trends across a group of employees can be compared against other work groups, other work locations, competitors, a group, company, or industry standard, or any other entity value, or standard. Employee physiological parameter data can thus be used to compare groups of employees and thus isolate employee groups showing high job satisfaction, which can be associated with greater work throughput or higher-quality work, or to isolate employee groups showing lesser job satisfaction, which can be associated with lesser work throughput or lower-quality work. However, estimated or determined physiological parameter data of the employee or a group of employees can be used in any other way.

The method can additionally include detecting physiological patterns indicative of sickness or emotion within the physiological record of the employee. This can be used to verify an absentee excuse, wherein the absentee excuse is associated with a given physiological pattern, or can be used to anticipate employee sickness or disease outbreak in the workplace. The physiological parameter pattern is preferably a pattern exhibited over time, but can alternatively be a pattern detected in a single biometric measurement. For example, a sickness excuse is associated with a physiological parameter pattern indicative of the flu, wherein a pattern of parameters indicative of sequentially decreasing employee energy levels detected within the physiological record associated with the employee can confirm or verify the sickness excuse. In another example, the parameter pattern can be indicative of chicken pox, wherein the parameter pattern includes regular skin discolorations (e.g., concentric white and red circles) within the biometric information that were not evident in prior records of the employee. However, the physiological patterns can be otherwise determined and used.

The method can additionally include generating a recommendation for the employee based on the extracted physiological parameter S700. In one variation, as shown in FIG. 11, in response to the extracted physiological parameter(s) of the employee matching a physiological parameter value or pattern indicative of an adverse event, such as sickness, anger, or exhaustion (e.g., beyond a predetermined threshold), the system generates a notification for the employee that recommends an action. For example, a notification can be generated in response to the heat pattern of the employee exceeding a predetermined threshold (e.g., the determined heat of the employee body or torso exceeding 37.5° C.) or exceeding a threshold difference from the historical heat pattern of the employee. The system can additionally prevent the employee from entering the workplace (e.g., by locking a door). The system can additionally send a notification to the employer. The recommendation for the employee is preferably generated in real-time, in response to identification of the employee in the field of view of the sensor, but can alternatively be generated asynchronously (e.g., and sent as a notification to the employee on the respective mobile device), or determined at any other suitable frequency.

The method can additionally include using the biometric information to authenticate the employee or user. In one example, a manager logs into a scheduling view, summary of the employee work records (e.g., as shown in FIG. 6), or any other suitable manager-associated output with a username and password, in addition to user verification through biometric information. In this variation, the biometric information is preferably recorded and verified at a predetermined frequency (e.g., every 10 seconds) while the user is logged into the system through the username and password. In response to a change in the user identified within the biometric information (e.g., a new user is identified or no user is identified), the user account is automatically logged out of the system. The biometric information is preferably measured by the device displaying the output, but can alternatively be measured by a sensor substantially permanently (e.g., mounted or riveted) or transiently (e.g., removably, such as by a wire, clip, adhesive, Velcro, etc.) coupled to the display device. However, the biometric information can be otherwise measured and utilized.

In one example of the method, in response to receipt of a verification request for a first employee absentee excuse, a first notification confirming the employee sickness is sent in response to the employee physiological record reflecting patterns consistent with the physiological parameter pattern associated with the absentee excuse, and a second notification invalidating the employee sickness is sent in response to the employee physiological record reflecting patterns inconsistent with the physiological parameter pattern associated with the absentee excuse or lacking the physiological parameter pattern associated with the absentee excuse.

In another example of the method as shown in FIG. 3A, the method includes: identifying the employee in a field of view of a camera at a clocking time; receiving an input from the employee for one of a clock-in selection and a clock-out selection; and updating a work record of the employee with the employee selection and the clocking time when the employee is positively identified in the field of view of the camera.

In another example of the method as shown in FIG. 4A, the method includes: identifying the employee in a field of view of a camera at a first time; clocking-in the employee at the first time given a clock-in selection from the employee when the employee is positively identified in the field of view of the camera; identifying the employee in a field of view of a camera at a second time; and clocking-out the employee at the second time given a clock-out selection from the employee when the employee is positively identified in the field of view of the camera.

The systems and methods of the preferred embodiment can be embodied and/or implemented at least in part as a machine configured to receive a computer-readable medium storing computer-readable instructions. The instructions are preferably executed by computer-executable components preferably integrated with the application, applet, host, server, network, website, communication service, communication interface, hardware/firmware/software elements of a user computer or mobile device, or any suitable combination thereof. Other systems and methods of the preferred embodiment can be embodied and/or implemented at least in part as a machine configured to receive a computer-readable medium storing computer-readable instructions. The instructions are preferably executed by computer-executable components preferably integrated by computer-executable components preferably integrated with apparatuses and networks of the type described above. The computer-readable medium can be stored on any suitable computer readable media such as RAMs, ROMs, flash memory, EEPROMs, optical devices (CD or DVD), hard drives, floppy drives, or any suitable device. The computer-executable component is preferably a processor but any suitable dedicated hardware device can (alternatively or additionally) execute the instructions.

As a person skilled in the art will recognize from the previous detailed description and from the figures and claims, modifications and changes can be made to the preferred embodiments of the invention without departing from the scope of this invention as defined in the following claims.

We claim:

1. A method for employee attendance tracking, comprising:
receiving an attendance status;
in response to receipt of the attendance status, recording an image of an employee, the image associated with a timestamp;
identifying the employee from the image using facial recognition in near-real time;
updating a work record for the employee based on the timestamp;
generating a reward for the employee based on the respective work record;
in response to identification of the employee, displaying an indicator of the reward to the employee on a screen concurrently displaying a field of view of an image recording device configured to record the image;
determining a physiological parameter for the employee from the image;
recording the physiological parameter in a physiological record for the employee;
generating a recommendation based on the physiological record for the employee; and
sending the recommendation to an employer of the employee.

2. The method of claim 1, wherein updating the work record further comprises:
calculating an amount of time between the first timestamp and a second timestamp of a prior image associated with the employee, the second timestamp comprising a timestamp most proximal to the first timestamp within the work record for the employee;
comparing the amount of time with a work schedule for the employee; and
generating and displaying a recommendation based on the difference between the amount of time and the work schedule.

3. The method of claim 1, wherein the attendance status comprises one of a check-in status and a check-out status.

4. A method for employee monitoring, comprising:
receiving biometric information unique to an employee, the biometric information comprising a timestamp;
identifying the employee based on the biometric information;
updating a work record associated with the employee based on the timestamp in response to employee identification;
analyzing the biometric information to extract a physiological parameter of the employee;
updating a physiological record associated with the employee; and
generating a recommendation for an employer based on the physiological record associated with the employee.

5. The method of claim 4, wherein receiving biometric information unique to the employee comprises receiving an image of a face of the employee, wherein identifying the employee based on the biometric information comprises automatically recognizing the face of the employee within the image using facial recognition.

6. The method of claim 4, wherein updating the work record associated with the employee further comprises determining an attendance status of the employee and updating the work record with the attendance status.

7. The method of claim 6, wherein determining the attendance status comprises receiving the attendance status from the employee.

8. The method of claim 6, wherein updating the work record further comprises:
calculating an amount of time worked by the employee in response to determination of a check-out attendance status; and
comparing the amount of time worked by the employee with a work schedule for the employee.

9. The method of claim 8, wherein determination of a check-out attendance status comprises:
comparing the timestamp to the employee work schedule, the work schedule comprising a start time and end time; and
determining that the timestamp is proximal the end time and distal the start time.

10. The method of claim 8, wherein further comprising adjusting a payroll associated with the employee based on the comparison.

11. The method of claim 4, wherein generating a recommendation for the employer comprises:
analyzing the physiological record in response to receipt of a verification request for an employee absentee excuse, the absentee excuse associated with a predetermined physiological parameter pattern;
sending a first notification in response to a pattern in the physiological record corresponding to the predetermined physiological parameter pattern;
sending a second notification in response to the physiological record lacking the predetermined physiological parameter pattern.

12. The method of claim 11, wherein analyzing the biometric information comprises extracting a measure for a physiological parameter indicative of employee stress from the biometric information.

13. The method of claim 4, wherein analyzing the biometric information comprises extracting a measure for a physiological parameter indicative of employee emotion from the biometric information.

14. The method of claim 13, wherein the recommendation is generated in response to the physiological parameter changing beyond a threshold rate.

15. The method of claim 13, wherein generating the recommendation comprises comparing a first set of physiological records associated with employees associated with a first location and a second set of physiological records associated with employees associated with a second location; and generating the recommendation based on a difference between a first average physiological parameter of the first set and a second average physiological parameter of the second set.

16. The method of claim 4, wherein the biometric information is associated with a location, wherein receiving the biometric information further comprises verifying that the location associated with the biometric information is a location associated with an employer of the employee.

17. The method of claim 16, wherein the location comprises an internet protocol address associated with the biometric information.

18. The method of claim 4, further comprising determining a time of biometric information receipt; and in response to a difference between the timestamp and the time of biometric information receipt exceeding a difference threshold, sending a request to record biometric information.
